(19) United States
(12) Patent Application Publication
(10) Pub. No.: US 2010/0017246 A1
(43) Pub. Date: Jan. 21, 2010

(54) SOFTWARE USER INTERFACE FOR SPECIFICATION OF PROJECT TASK DEPENDENCIES AND DEADLINES

(76) Inventors: Glenn H. Farrell, Peoria, IL (US); Gary J. Rhodes, Springfield, IL (US)

Correspondence Address: Russ Weinzimmer, 614 Nashua Street, Suite 53, Milford, NH, 03055, US

(21) Appl. No.: 12/176,400

(22) Filed: Jul. 20, 2008

(51) Int. Cl. G06Q 10/00

(52) U.S. Cl. 705/8

(57) ABSTRACT

A software user interface applicable to project tracking software and a method of use thereof is disclosed that enables entry of dependencies and relative deadlines for sub-tasks of projects. Dependency indicators specify dependencies of sub-tasks on the project start time or on completion times of other sub-tasks, and duration indicators specify the timing of deadlines relative to those time events. A plurality of deadlines can apply to the same sub-task so as to indicate thresholds of overdue urgency, and visual indications such as colors can be assigned to sub-tasks within the plurality to enable indications of overdue urgency in visual presentations of project status. Sub-task visual elements can be included that list and name the sub-tasks, and relate the sub-tasks to dependency indicators. Permissions can be entered that control the abilities of users to view and/or enter parameters. The method can operate over a network or the internet.

### FIELD OF THE INVENTION

The invention generally relates to software for managing projects, and more specifically to software user interfaces that enable input of project related parameters.

### BACKGROUND OF THE INVENTION

Modern life is getting faster and more complicated. People are expected to accomplish more and more, quicker than ever before. New product developments that used to take years now require weeks. Ad campaigns are executed, movies launched, buildings erected, websites built, all in a fraction of the time these projects formerly required. The complexity of individual projects is growing too. More functionality is required and more compatibility issues need to be addressed, frequently in light of complex, international regulatory requirements.

It is often convenient to manage a project by dividing the project into sub-tasks that must be completed so as to complete the project as a whole. For example, sub-tasks required so as to construct a building may include approval of architectural drawings, ordering of materials, digging the foundation, pouring the foundation, erecting the frame, and so forth. Some sub-tasks are relatively independent of the others, such as choosing the furniture, and can be carried out at almost any time after a project begins. Other sub-tasks are strongly dependent on the completion of other sub-tasks. For example, the frame of a building cannot be erected until the foundation has been poured.

Project tracking software tools are often used to track and manage the progress and status of projects. These software tools typically display graphs and/or charts that provide a visual overview of an entire project and of the status of the various sub-tasks included in the project. A timeline is typically used to indicate expected and actual durations of sub-tasks, as well as the actual completion status of each sub-task. And a specific time or date is often indicated as a deadline for each sub-task, with special overdue indications being presented for sub-tasks that are not completed by their applicable deadlines.

Project tracking software tools often allow specification of dependencies between sub-tasks, so as to guide the establishment of deadlines and provide a better understanding of the overall status of a project. For example, the sub-task of erecting a frame for a building may be overdue because the foundation has not yet been poured. If it is specified that the frame erecting sub-task is dependent on completion of the foundation pouring sub-task, the software can indicate the dependency in such a way that consequential delays (e.g. erecting the frame) can be more or less ignored and root causes of delays (e.g. pouring the foundation) can be more quickly identified.

However, traditional project tracking software tools are not well suited to tracking projects for which the lengths of time required to complete sub-tasks are more important than the absolute dates of completion. For example, a sales manager may wish to track the promptness of sales personnel in responding to sales inquiries. Each sales case can be tracked as a “project,” each of which includes a common set of sub-tasks such as “send marketing literature,” “receive bid request,” and “respond to bid request.” In this example, it might be very difficult to establish in advance a timeline and expected dates of completion for each sales case. But it might nevertheless be very helpful and important to track whether or not sales professionals are executing certain sub-tasks within specified time intervals once the preceding sub-tasks are completed.

For example, it might be impossible to predict when bid requests will arrive, but it may nevertheless be very important to track that bid responses are completed within a week after bid requests are received.

Another limitation of traditional project tracking software tools is that they tend to provide information regarding overdue sub-tasks that is incomplete and/or misleading. For example, a traditional project tracking software tool may indicate that two different sub-tasks are overdue by similar amounts of time, and this might create the impression that the delays are equally urgent, while in reality the significances of the delays are very different. This shortcoming is made even worse when sub-tasks are displayed in relation to time-proportional timelines, because the significance of a degree of lateness for a sub-task will inherently tend to appear to be relative to the overall duration of the sub-task. For example, when displayed relative to a time-proportional timeline, a three month sub-task may appear to be only “slightly” overdue if it is three days overdue, while a five day sub-task may appear to be grossly overdue if it is three days overdue. Yet the delay of the three month sub-task may actually be much more critical than the delay of the five day sub-task.

### SUMMARY OF THE INVENTION

A software user interface applicable to project tracking software tools is claimed. The software user interface enables a user to specify dependencies of sub-tasks of a project on time events that can be either completion times of other sub-tasks or the start time of the project. Deadlines for sub-tasks can be specified in terms of durations of time following the time events on which the sub-tasks depend. A subtask is thereby indicated as being overdue only if it exceeds the specified duration, and not if it is delayed by a previous sub-task on which it depends.

Preferred embodiments allow a plurality of deadlines to be defined for a given sub-task, thereby establishing thresholds of rising urgency as the sub-task becomes increasingly overdue. In some embodiments, distinguishing visual indications are associated with the deadlines within each plurality of deadlines, such that the visual indications can be used when presenting an overview of the status of the project to visually indicate degrees of urgency of overdue sub-tasks. This approach provides an enhanced and generally more meaningful visual presentation of the status of a project, as compared to traditional approaches that present the status of sub-tasks according to a time-proportional timeline and/or report only the quantitative amount of time by which a sub-task is overdue.

One general aspect of the invention is an article of manufacture for enabling entry into a computer of dependency and deadline determining parameters applicable to at least one project, each project including a plurality of sub-tasks with which deadlines can be associated. The article of manufacture is computer-readable media containing software that is able to direct the actions of a computer so as to cause the computer to present a user interface including a dependency indicator applicable to a specific sub task of a specific project. The dependency indicator enables a user to specify a dependency event which is one of a starting time of the specific project and a completion time of another sub-task of the specific project, such that at least one deadline associated with the specific sub-task will be determined at least in part according to the dependency event. The dependency indicator is also associated with at least one time duration indicator, each time duration indicator enabling a user to specify a duration of time, the duration of time beginning at the dependency event, and the duration of time at least partly determining a deadline associated with the specific sub-task.

In preferred embodiments, the dependency indicator and the associated time duration indicator are included within the same user interface. And in some preferred embodiments, each time duration indicator specifies a deadline for the sub-task to which the dependency indicator associated with the time duration indicator applies, the deadline being the time at which the duration specified by the time duration indicator ends.

In various preferred embodiments sub-task visual elements are included, each of which can be associated with a sub-task and with a dependency indicator, thereby signifying that the associated dependency indicator applies to the associated sub-task. And in some of these embodiments the sub-task visual elements enable a user to specify the sub-tasks that are included in a project, and/or each sub-task of each project is associated with a sub-task visual element.

In preferred embodiments, a ranked plurality of time duration indicators can be associated with a dependency indicator, and a distinct visual indication can be assigned to each time duration indicator within the ranked plurality according to its ranking within the ranked plurality. In some of these embodiments each visual indication includes at least one of the following: a color; a shading; a cross hatching pattern; a blinking rate; a size; an orientation; a configuration; an alphanumeric indication; a choice of font characteristic; and a pop-up indication activated by a pointing device.

And in some preferred embodiments, a permission-setting interface is included that enables an authorized user to specify permissions that determine which users are able to view or enter deadline determining parameters. The permissions can either apply to specific users and to all deadline-determining parameters, or they can apply to specific users and to specific deadline-determining parameters.

A second general aspect of the invention is a method for entering into a computer dependency and deadline determining parameters applicable to at least one project, each project including a plurality of sub-tasks with which deadlines can be associated. The method includes operating a computer controlled by software that is able to direct the actions of the computer so as to cause the computer to present a user interface including a dependency indicator applicable to a specific sub task of a specific project. The dependency indicator enables a user to specify a dependency event which is one of a starting time of the specific project and a completion time of another sub-task of the specific project, such that at least one deadline associated with the specific sub-task will be determined at least in part according to the dependency event. The dependency indicator is also associated with at least one time duration indicator, each time duration indicator enabling a user to specify a duration of time, the duration of time beginning at the dependency event, and the duration of time at least partly determining a deadline associated with the specific sub-task.

In preferred embodiments, the dependency indicator and the associated time duration indicator are included within the same user interface. And in some preferred embodiments, each time duration indicator specifies a deadline for the sub-task to which the dependency indicator associated with the time duration indicator applies, the deadline being the time at which the duration specified by the time duration indicator ends.

In various preferred embodiments sub-task visual elements are included, each of which can be associated with a sub-task and with a dependency indicator, thereby signifying that the associated dependency indicator applies to the associated sub-task. And in some of these embodiments the sub-task visual elements enable a user to specify the sub-tasks that are included in a project, and/or each sub-task of each project is associated with a sub-task visual element.

In preferred embodiments, a ranked plurality of time duration indicators can be associated with a dependency indicator, and a distinct visual indication can be assigned to each time duration indicator within the ranked plurality according to its ranking within the ranked plurality. In some of these embodiments each visual indication includes at least one of the following: a color; a shading; a cross hatching pattern; a blinking rate; a size; an orientation; a configuration; an alphanumeric indication; a choice of font characteristic; and a pop-up indication activated by a pointing device.

And in some preferred embodiments, a permission-setting interface is included that enables an authorized user to specify permissions that determine which users are able to view or enter deadline determining parameters. The permissions can either apply to specific users and to all deadline-determining parameters, or they can apply to specific users and to specific deadline-determining parameters.

In certain preferred embodiments the software operates at least primarily on a server computer and the user interface is displayed on a client computer that is in communication with the server computer through a network, and in some of these preferred embodiments the network is the internet.

### BRIEF DESCRIPTION OF THE DRAWINGS

FIG. 1A illustrates a graphical user interface of a preferred embodiment that enables assignment of a single relative deadline to each sub-task of a project, the relative deadline being specified as a time period beginning at a specified time event;

FIG. 1B illustrates a graphical user interface of a preferred embodiment similar to FIG. 1A, except that it also enables assignment of a second deadline to each sub-task, the second deadline being an absolute deadline specified as a calendar date; and

FIG. 2 illustrates a graphical user interface of a preferred embodiment that enables assignment of two relative deadlines to each sub-task of a project, the first relative deadline being associated with the color yellow and the second relative deadline being associated with the color red.

### DETAILED DESCRIPTION OF PREFERRED EMBODIMENTS

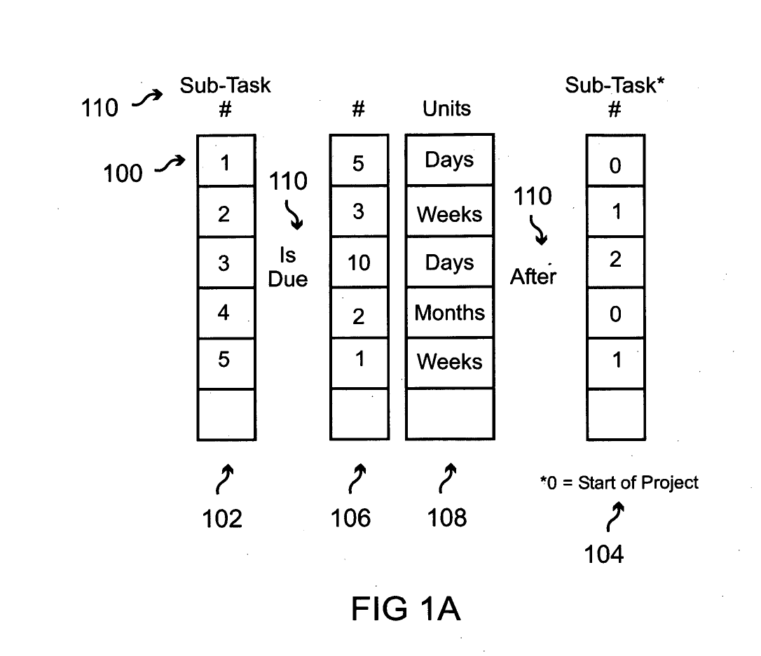

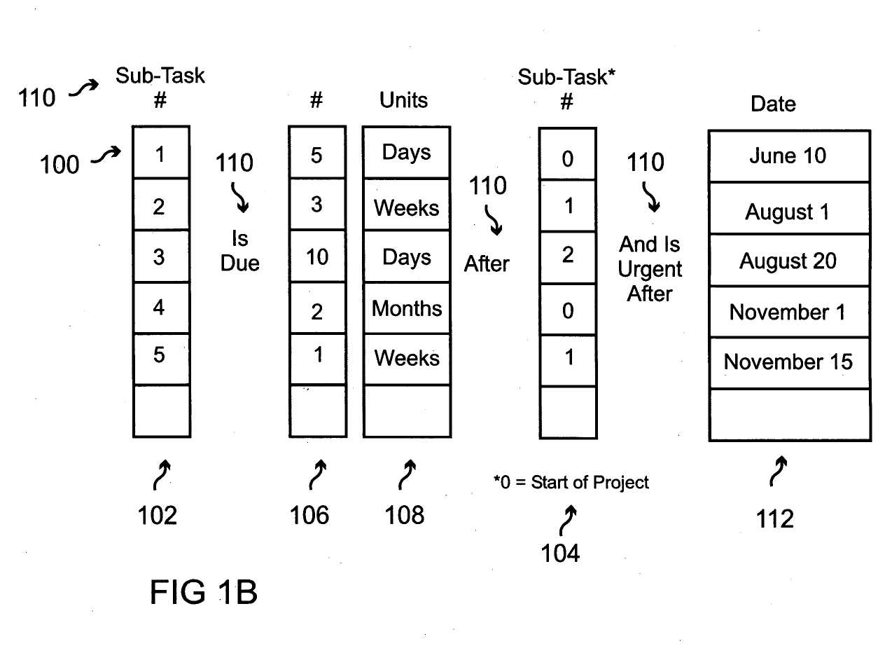

With reference to FIG. 1A, the present invention is a user interface applicable to a project tracking software tool that enables a user to define dependencies between subtasks of a project, and to assign relative deadlines to the sub-tasks according to durations that begin with a time event that is either the start of the project or the completion of another sub-task. In the embodiment of FIG. 1A, the user interface graphically represents sub-tasks as horizontal rows (100a through 100f) composed of cells in a plurality of aligned but separated columns. The sub-tasks of a project are numbered and are referred to by placing the sub-task numbers in the cells of a sub-task identifying column 102. In similar embodiments, sub-tasks are represented as vertical columns composed of cells in a plurality of aligned rows.

In FIG. 1A, for each sub-task included in the sub-task identifying column 102 a corresponding entry in a dependency indicating column 104 indicates the time event upon which the sub-task depends. In this embodiment, a zero entry in the dependency indicating column 104 indicates dependency upon the start time of the project, while any other numeric entry in the dependency indicating column 104 indicates dependency upon the sub-task referred to by the entered number.

In the embodiment of FIG. 1A a single time duration indicator is included for each sub-task. The time duration indicators are composed of pairs of cells arranged in adjacent columns 106, 108. Numbers are entered into the first column 106 and corresponding units, such as Hours, Days, Weeks, Months, and Years, are entered into the adjacent column 108.

Explanatory headings accompany the columns 102, 104, 106, 108 in FIG. 1A so as to form virtual sentences that explain the meanings of the entries in the cells. For example, the first row 100a can be interpreted as “Sub-Task number 1 is due five days after the start of the project” and the second row 100b can be interpreted as “Sub-Task number 2 is due three weeks after completion of Sub-Task number 1.”

It can be seen from FIG. 1A that the first and fourth sub-tasks have relative deadlines that depend only on the start date of the project, such that the deadlines become absolute deadlines once the project is begun. The other sub-tasks have relative deadlines that are defined only in terms of durations of time that elapse after completion of a preceding sub-task. These sub-tasks will not be identified as being “overdue” so long as they are completed in the expected amounts of time, regardless of whether the preceding sub-tasks upon which they depend were completed on time.

FIG. 1B illustrates a preferred embodiment that is similar to the embodiment of FIG. 1A, except that an additional, absolute deadline is defined for each sub-task, such that the sub-task is “due” by the first deadline and “urgently overdue” if it is not completed by the second deadline. The embodiment of FIG. 1B assigns the first deadline of each sub-task as a relative deadline that depends either on the start time of the project or the completion time of another sub-task. However, the second deadline is specified as an actual date, allowing the completion times of the sub-tasks to be separately tracked while also comparing the progress of the overall project to a calendar-oriented project completion timeline.

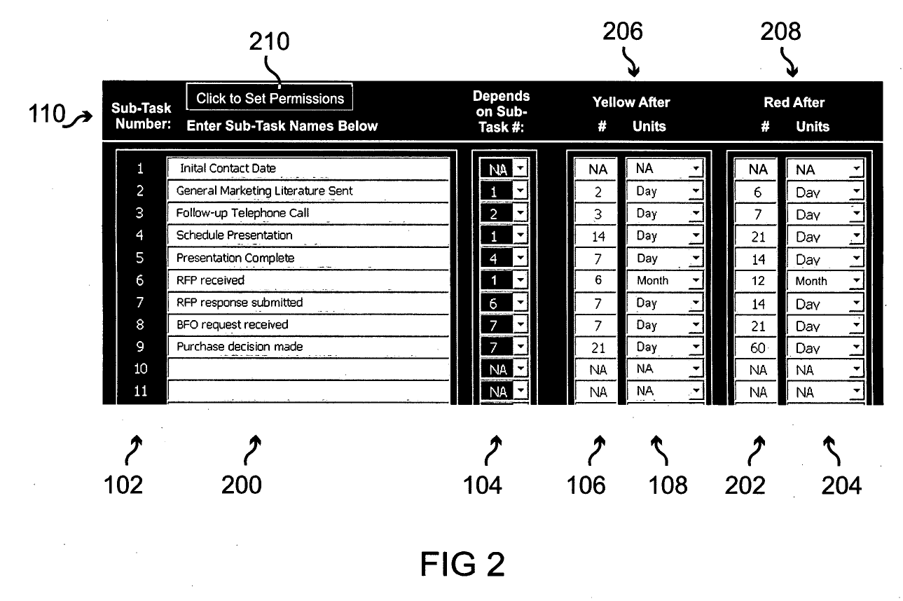

FIG. 2 illustrates a preferred embodiment of the invention that is similar to the embodiments of FIG. 1A and FIG. 1B, but also includes a column of sub-task graphical elements 200 that enable a user to define how many sub-tasks are included in a project and to specify the names of the sub-tasks. As in the embodiment of FIG. 1B, the embodiment of FIG. 2 enables definition of two deadlines for each sub-task, but in the embodiment of FIG. 2 both of the deadlines are relative deadlines, and are specified in an identical manner, namely by entering time durations into a pair of columns 106, 108, 202, 204, the first of which 106, 202 accepts a number and the second of which 108, 204 accepts a specification of the units applicable to the number. In this embodiment, the beginning of the project is defined as the first sub-task, so that other sub-tasks with deadlines that depend only on the start date of the project are indicated in as being dependent on the first sub-task.

In the embodiment of FIG. 2, colors are used as visual indications for the two deadlines that apply to each sub-task. Specifically, the color yellow 206 is used for the first deadline for each sub-task, and the color red 208 is used for the second deadline for each sub-task. So as to make this association visibly clear, the background colors of the time duration indicators are set to yellow 106 and red 202 respectively. In similar embodiments, other visual indications are used, such as shading, cross hatching, rate of blinking, size of graphical element, a numerical indication, or even a pop-up indication activated by a mouse or other pointing device.

In this embodiment, the color assignments are uniform for all sub-tasks, while in other embodiments different visual indications can be used for different sub-tasks and/or different projects. The assigned visual indications can be used when presenting an overview of the status of a project or a plurality of projects so as to provide indications of degrees of urgency associated with overdue sub-tasks, the degrees of urgency being not necessarily apparent from indications that only present the amounts of time by which sub-tasks are overdue. In some preferred embodiments a user is able to specify visual indications to be assigned to different deadlines that apply to the same sub-task. The specifications can be either uniform for all sub-tasks, or applicable to specific sub-tasks.

The embodiment of FIG. 2 also includes a control 210 that activates a permission-setting interface that enables determination by an administrator of permissions that specify which users are allowed to view and/or enter deadline determining parameters. In various embodiments, permissions can be granted that allow specific users to view and/or enter any desired deadline determining parameter. In other preferred embodiments, permissions can be granted that allow specific users to view and/or enter only specified deadline determining parameters.

Depending on the embodiment, the user interface of the present invention can be displayed on any electronic display, including the screen of a computer, such as a personal computer, or on the display of a hand-held device such as a personal digital assistant “PDA,” cell phone, or similar device. The computer or other electronic device that generates the user interface can be a local device, or it can be a server computer or other electronic device that is in communication by wired or wireless means with the electronic display, for example over the internet over the telephone network, or over some other network.

Other modifications and implementations will occur to those skilled in the art without departing from the spirit and the scope of the invention as claimed. Accordingly, the above description is not intended to limit the invention except as indicated in the following claims.

What is claimed is:

1. An article of manufacture for enabling entry into a computer of dependency-determining and deadline-determining parameters applicable to at least one project, each project including a plurality of sub-tasks with which deadlines can be associated, the article of manufacture comprising:
computer-readable media containing software that is able to direct the actions of a computer so as to cause the computer to present a user interface including a dependency indicator applicable to a specific sub task of a specific project,
the dependency indicator enabling a user to specify a dependency event which is one of a starting time of the specific project and a completion time of another sub-task of the specific project, such that at least one deadline associated with the specific sub-task will be determined at least in part according to the dependency event; and
the dependency indicator being associated with at least one time duration indicator, each time duration indicator enabling a user to specify a duration of time, the duration of time beginning at the dependency event, and the duration of time at least partly determining a deadline associated with the specific sub-task.

2. The article of manufacture of claim 1, wherein the dependency indicator and the associated time duration indicator are included within the same user interface.

3. The article of manufacture of claim 1, wherein for each sub-task of each project, at most one dependency indicator applies to the sub-task.

4. The article of manufacture of claim 1, wherein each time duration indicator specifies a deadline for a sub-task, the deadline being the time at which the duration specified by the time duration indicator ends.

5. The article of manufacture of claim 1, further comprising a sub-task visual element that can be associated with a sub-task and with a dependency indicator, thereby signifying that the associated dependency indicator applies to the associated sub-task.

6. The article of manufacture of claim 5, wherein the sub-task visual elements enable a user to specify sub-tasks that are included in a project.

7. The article of manufacture of claim 5, wherein each sub-task of each project is associated with a sub-task visual element.

8. The article of manufacture of claim 1, wherein a ranked plurality of time duration indicators can be associated with a dependency indicator, and a distinct visual indication can be assigned to each time duration indicator according to its ranking within the ranked plurality.

9. The article of manufacture of claim 8, wherein each visual indication includes at least one of:
a color;
a shading;
a cross hatching pattern;
a blinking rate;
a size;
an orientation;
a configuration;
an alphanumeric indication;
a choice of font characteristic; and
a pop-up indication activated by a pointing device.

10. The article of manufacture of claim 1, further comprising a permission-setting interface that enables an authorized user to specify permissions that determine which users are able to at least one of:
view deadline determining parameters; and
enter deadline determining parameters,
the permissions including at least one of:
permissions that apply to specific users and to all deadline-determining parameters; and
permissions that apply to specific users and to specific deadline-determining parameters.

11. A method for entering into a computer dependency and deadline determining parameters applicable to at least one project, each project including a plurality of sub-tasks with which deadlines can be associated, the method comprising:
operating a computer controlled by software that is able to direct the actions of the computer so as to cause the computer to present a user interface including a dependency indicator applicable to a specific sub task of a specific project,
the dependency indicator enabling a user to specify a dependency event which is one of a starting time of the specific project and a completion time of another sub-task of the specific project, such that at least one deadline associated with the specific sub-task will be determined at least in part according to the dependency event; and
the dependency indicator being associated with at least one time duration indicator, each time duration indicator enabling a user to specify a duration of time, the duration of time beginning at the dependency event, and the duration of time at least partly determining a deadline associated with the specific sub-task.

12. The method of claim 11, wherein the dependency indicator and the associated time duration indicator are included within the same user interface.

13. The method of claim 11, wherein for each sub-task of each project at most one dependency indicator applies to the sub-task.

14. The method of claim 11, wherein each time duration indicator specifies a deadline for the sub-task to which the dependency indicator associated with the time duration indicator applies, the deadline being the time at which the duration specified by the time duration indicator ends.

15. The method of claim 11, further comprising sub-task visual elements, each of which can be associated with a sub-task and with a dependency indicator, thereby signifying that the associated dependency indicator applies to the associated sub-task.

16. The method of claim 15, wherein the sub-task visual elements enable a user to specify sub-tasks that are included in a project.

17. The method of claim 15, wherein each sub-task of each project is associated with a sub-task visual element.

18. The method of claim 11, wherein a ranked plurality of time duration indicators can be associated with a dependency indicator, and a distinct visual indication can be assigned to each time duration indicator within the ranked plurality according to its ranking within the ranked plurality.

19. The method of claim 18, wherein each visual indication includes at least one of:
a color;
a shading;
a cross hatching pattern;
a blinking rate;
a size;
an orientation;
a configuration;
an alphanumeric indication;
a choice of font characteristic; and
a pop-up indication activated by a pointing device.

20. The method of claim 11, further comprising a permission-setting interface that enables an authorized user to specify permissions that determine which users are able to at least one of:
view deadline determining parameters; and
enter deadline determining parameters,
the permissions including at least one of:
permissions that apply to specific users and to all deadline-determining parameters; and
permissions that apply to specific users and to specific deadline-determining parameters.

21. The method of claim 11, wherein the software operates at least primarily on a server computer and the user interface is displayed on a client computer that is in communication with the server computer through a network.

22. The method of claim 21, wherein the network is the internet.
